(19) United States
(12) Patent Application Publication
(10) Pub. No.: US 2016/0017604 A1
(43) Pub. Date: Jan. 21, 2016

(54) LIGHTING ASSEMBLY

(71) Applicant: CERTAINTEED CANADA, INC., Toronto (CA)

(72) Inventors: Ronald WHITE, Holland Landing (CA); Martin D. GERKES, Toronto (CA)

(73) Assignee: CERTAINTEED CANADA, INC., Toronto (CA)

(21) Appl. No.: 14/827,845

(22) Filed: Aug. 17, 2015

Related U.S. Application Data
(63) Continuation of application No. PCT/CA2015/000414, filed on Jun. 26, 2015.

(30) Foreign Application Priority Data
Jul. 16, 2014 (CA) 2857004

(51) Int. Cl. E04B 9/00; F21S 4/00; F21S 8/04

(52) U.S. Cl. CPC E04B 9/006; F21S 8/046; F21S 4/008; F21Y 2103/003

(57) ABSTRACT

A lighting system for ceiling grid systems advantageously uses a grid member designed to cooperate with a strip light to secure the strip light generally aligned beneath the grid system. The grid system can be initially installed with the cooperating grid members at specified locations. The strip lights can then be installed to the grid system. This arrangement simplifies installation particularly installations in commercial type spaces and larger scale architectural projects.

This application is a continuation of International Patent Application PCT/CA2015/000414 filed on Jun. 26, 2015 that claims priority of Canadian application SN 2,857,004 filed on Jul. 16, 2014.

### FIELD OF THE INVENTION

The present invention relates to strip lighting, and in particular relates to strip lighting for use in association with grid type ceiling systems.

### BACKGROUND OF THE INVENTION

Low voltage lighting systems have gained substantial acceptance in the market place and narrow profile elongate strip lighting has been used in association with ceiling grid systems. The actual strip lighting is often a series of light-emitting diodes (LEDs) located in a common housing.

In one known prior art arrangement the actual strip light is a cross member of a T-bar grid system. The strip light is an integral component of the T-bar grid member and the lamp is selectively connected to a low voltage driver arrangement provided above the ceiling.

There remains a need to provide a system that allows selective securement of strip lighting to a ceiling grid system where the ceiling grid system is installed in a conventional manner and strip lighting is secured to the grid system.

For many large scale commercial type applications, grid ceiling systems are initially installed by personnel who are not directly responsible or qualified with respect to the installation of electrical systems. The ceiling system is typically designed to allow light fixtures to be installed by electricians etc. after installation of the grid system. There remains a need to provide a system that allows strip lighting to be installed in such a conventional manner.

### SUMMARY OF THE INVENTION

The present invention provides a releasable securing system where strip lighting cooperates with a structural member of the grid ceiling system.

Specialized grid members are used in association with concealed type ceiling paneling systems or traditional T-bar type systems. The present design utilizes a releasable connection of a separate strip light housing to the grid member whereby the strip lighting is installed after the grid system has been put in place and is an integrated component of the ceiling system.

The ceiling grid system according to the present invention receives an LED strip light and the system comprises a series of connected grid members for supporting and securing the peripheral edge of ceiling panels aligned with the grid system. At least some of the grid members have a downwardly opening recess that extends in the length of the grid member and the downwardly opening recess releasably engages and secures an LED strip light such that the strip light is exposed on a lower surface of the grid network.

### BRIEF DESCRIPTION OF THE DRAWINGS

Preferred embodiments of the invention are shown in the drawings, wherein:

FIG. 1 is a partial perspective view of a ceiling grid system with one strip light exposed on a lower surface of the ceiling;

FIG. 2 is a partial perspective view showing the end section of a secured strip light and four adjacent panels of the ceiling grid system;

FIG. 3 is a top view of the ceiling system of FIG. 1;

FIG. 4 is a partial perspective view showing the end section of two cross members of the grid supported on a main grid member;

FIG. 5 is a partial perspective view of a main grid member with one of the cross members having an LED light secured thereto;

FIG. 6 is a further perspective view showing an

LED strip light secured beneath a cross member;

FIG. 7 is a partial exploded view showing an LED strip light about to receive three spring clips in combination with a cross member of a grid system designed to releasably support the LED strip light;

FIG. 8 is an end view of a cross member, a spring clip and a strip light aligned beneath the cross member;

FIG. 9 is a further exploded view of the cross member, the spring clip and a lamp extrusion member that will receive LED lamps;

FIG. 10 is a perspective view of the spring clip;

FIG. 11 is a perspective view of a strip light secured to the cross member;

FIG. 12 is a sectional view showing the cross member and the lamp with spring clips secured thereto;

FIG. 13 is a perspective view of the strip light; and

FIG. 14 is an end view of the strip light with a received securing clip.

### DETAILED DESCRIPTION OF THE PREFERRED EMBODIMENTS

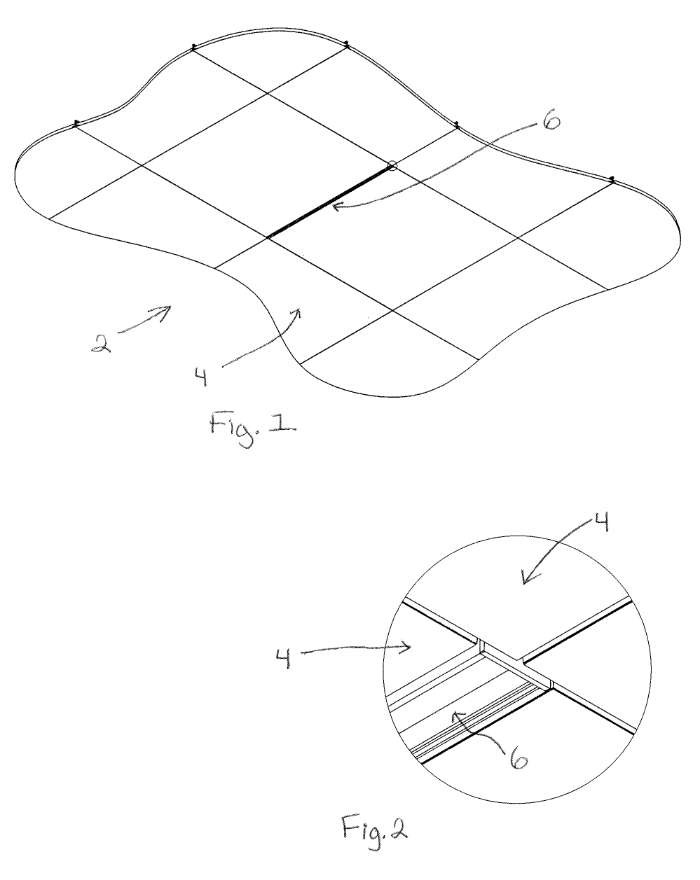

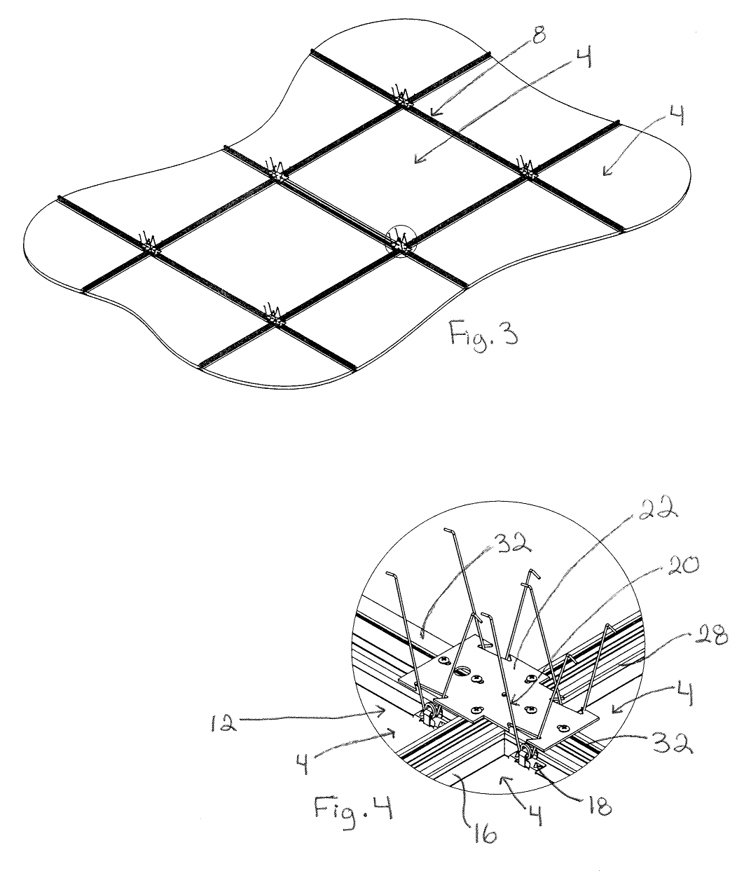

The ceiling grid paneling system 2 shown in FIGS. 1 and 3 includes a series of secured ceiling panels 4, a grid system 8 having a series of grid connection nodes 10 and a LED strip light 6 secured beneath one of the cross grid members and abutting two ceiling panels. Details of the LED strip light 6 and its relationship to the adjacent panels is shown in FIG. 2. It is preferred that the LED strip light in this case projects marginally below the lower surface of the ceiling panels. A large portion of the LED housing is hidden by the adjacent ceiling panels. The LED strip light 6 does have a certain width and therefore the two abutting adjacent panels have been cut down in size to accommodate the LED strip light.

In FIG. 3 it can be seen that the grid system 8 is exposed and in this embodiment, the ceiling grid paneling system is a concealed grid system where the grid members are hidden by the ceiling panels suspended below the grid system. Such a concealed ceiling panel grid system is in contrast to the traditional T-bar type ceiling grid system where the grid members are exposed and form part of the lower surface of the ceiling. The present system of securing the LED strip light to a grid member can also be adapted for securement to a specialized cross member of a T-bar grid system. In this case the lower edge of the strip light 6 preferably would project slightly below the lower surface of the ceiling panels.

In the preferred ceiling grid paneling system as shown in FIG. 4, the individual ceiling panels 4 have a series of panel clips that engage the lower surface of the ceiling panel, and in combination with connection torsion springs, engage the top connecting plate 22 to suspend the panels beneath the grid system. The top connecting plate 22 includes a series of slots for receiving the arms of the torsion spring and the connecting plate also includes a series of ports that receive mechanical screws which engage receiving channels in the connecting members. In this way the grid members are connected via the top connecting plate and maintained in accurate alignment. Typically there is a main grid member, in this case shown as 28, and conventional cross grid members 32 extend between adjacent main grid members. For the strip light the conventional cross grid members are preferably replaced with the modified cross grid member 30.

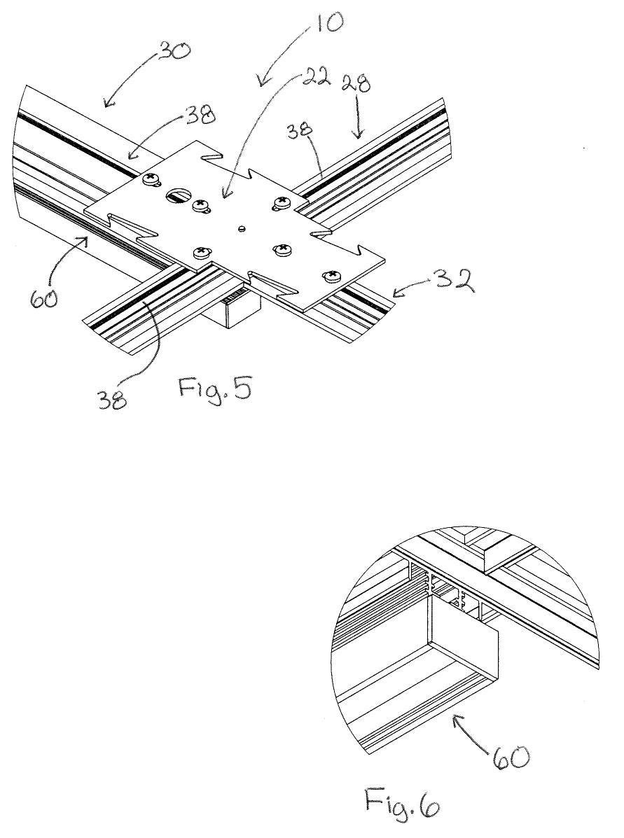

The partial perspective view of FIG. 5 shows a connection node 10 where the top connecting plate 22 is secured to a modified cross grid member 30 that is adapted to releasably engage an LED lamp housing 60. The LED lamp housing 60 is aligned beneath the modified cross grid member 30. The top portion of the modified cross grid member 30 engages the top connecting plate 22 in the same manner as the other grid members. In FIG. 6 it can be seen that the lamp housing 60 projects downwardly from the grid system and this additional distance is selected to be appropriate according to whether this is a suspended paneling ceiling system as shown in the earlier drawings or for a different type of paneling system such as a T-bar system.

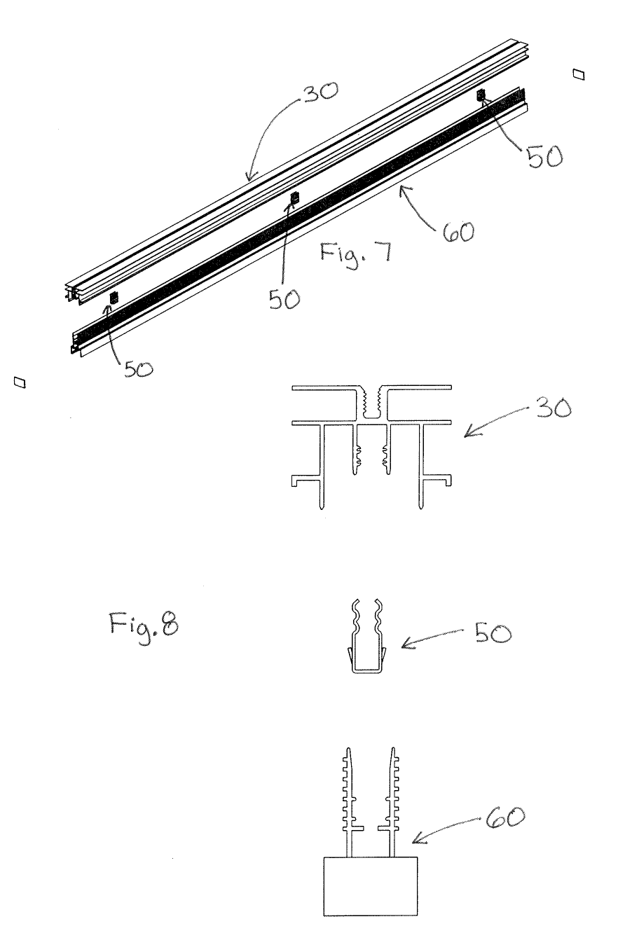

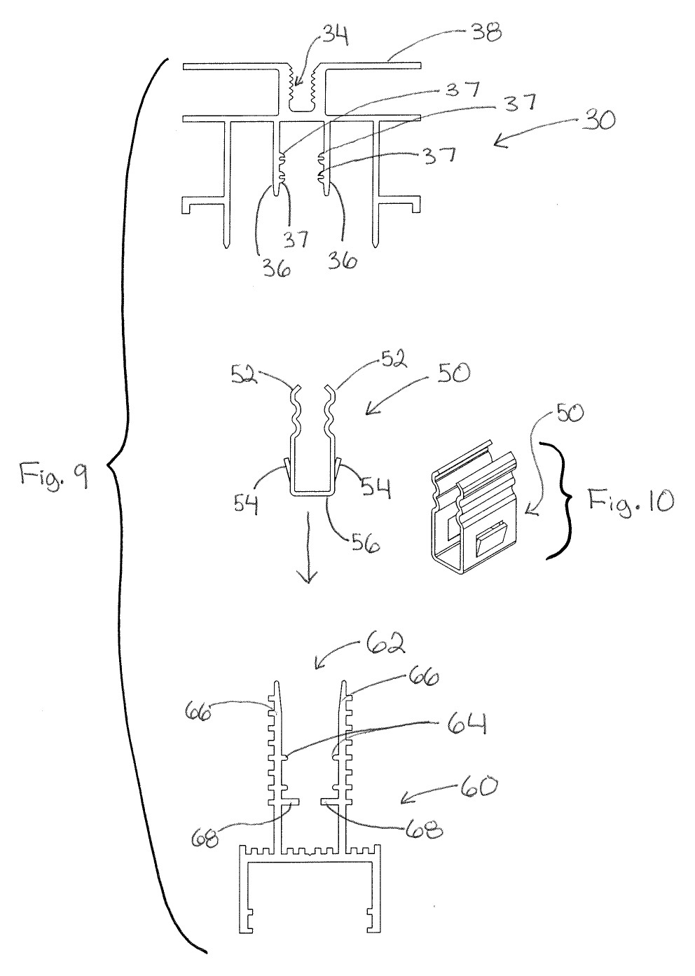

FIGS. 7 and 8 show details of the cooperation of the modified cross member 30, the lamp housing 60 and a spring clip 50 that engages the lamp housing and allows for releasable securement of the lamp housing beneath the modified grid member.

The spring clips 50 as shown in FIG. 7 are positioned at appropriate positions along the length of the lamp housing 60 and are received in a securing recess 62 of the lamp housing. The spring clip 50 is preferably of a spring steel and is inserted downwardly into the securing recess 62 and is held in the recess by means of the retaining tabs 54 of the spring clip. Basically, as the spring clip 50 is forced into the securing recess 62 the tabs 54 bend inwardly and will cam past the retaining stub arms 64 which project into the securing recess 62. The base 56 of the spring clip will bottom out on and be supported on the base arms 68 that also extend into the securing recess. The securing recess is defined either side thereof by the limiting fingers 66. As shown, the spring clip 50 includes its own spring arms 52 with an undulating surface for engaging securing projections of the retaining arms 36 of the modified cross member 30.

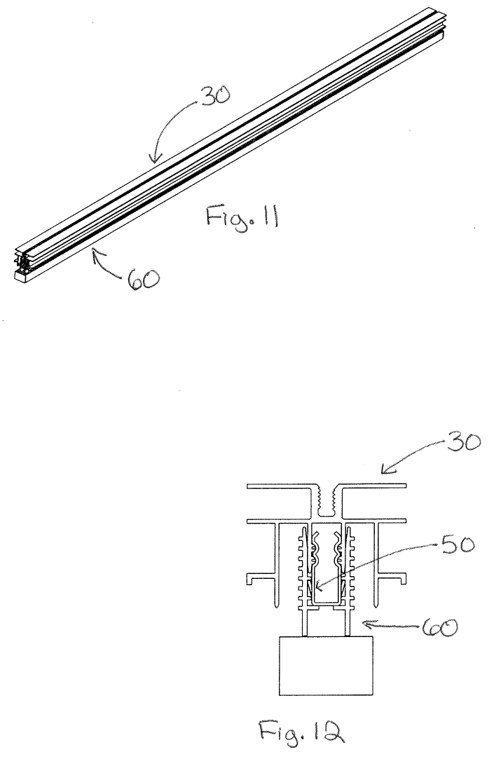

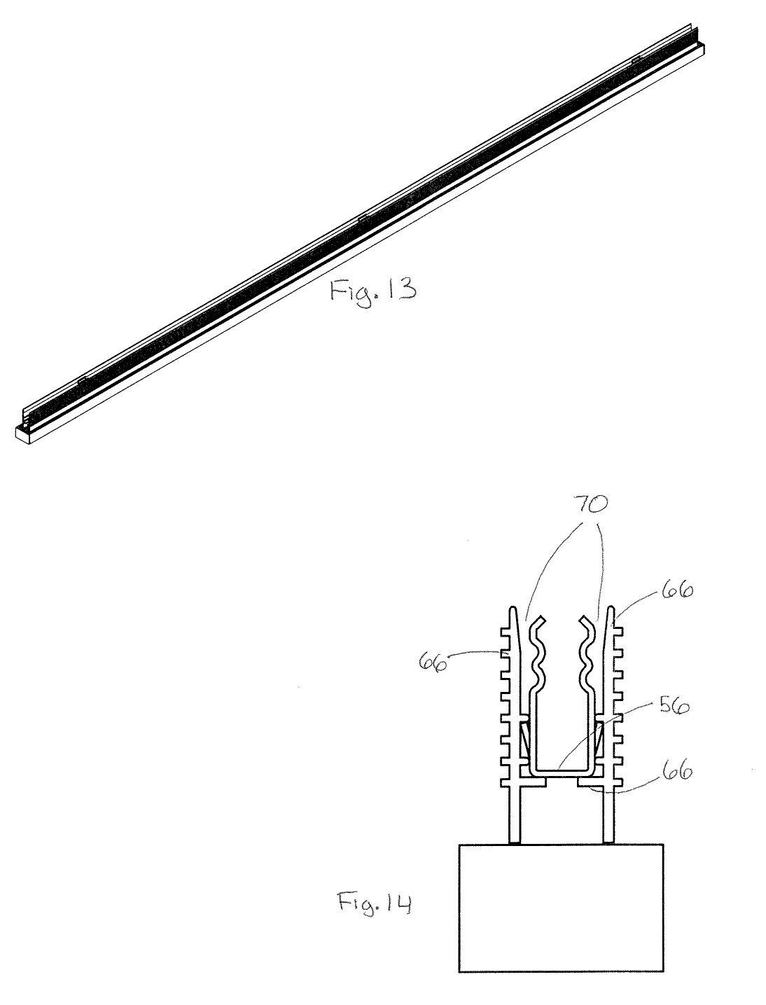

FIGS. 11 and 12 show the modified cross member 30 having the lamp housing 60 secured thereto. As shown in the sectional view of FIG. 12, the lamp housing 60 with the spring clip 50 secured in the securing recess 62 is moved upwardly such that the retaining arms 36 are positioned to go between the spring arms 52 and the adjacent limiting fingers 66 of the lamp housing 60. Basically the spring arms 52 may be forced inwardly allowing the retaining arms 36 to pass into the gap and securing projections 37 engage recesses in the spring arms 52 as shown.

It has been found that three spring clips spaced in the length of a lamp housing 60 of a length of approximately four feet is sufficient to securely retain the lamp housing to the grid member however additional spring clips can be provided. The spring clips are placed at appropriate positions in the lamp housing typically when a light strip is made. The locking tabs 54 not only retain the clip in the securing recess 62, they also serve to limit movement of the spring clip in the length of the extruded lamp housing. With the particular cooperation between the modified cross member 30 and the lamp housing 60 the actual lower surface of the light strip is accurately located below the grid. Basically the spring clip 50 bottoms out on the base arms 68 thereby accurately locating the spring clip and the retaining arms 36 with the securing ridges 37 accurately locate within the recesses of the spring clip.

In the embodiment shown, the strip layout has the lower surface thereof slightly below the finished surface of the ceiling. The actual electrical connection of the lamp housing 60 to a power source can be made through the center of the grid by the ports provided in the length of the modified cross member 30. Typically these ports pass through the securing recess 34 and into the space between the limiting fingers 60 and to the electrical components secured within the lamp housing. A low voltage power source can be connected above the grid and the lamp selectively connected. The lamp housing 60 with a finished product will include a lens at the bottom of the lamp end caps either end of the lamp housing and may include a suitable connector.

The lighting strip has been described as having a series of LED diodes as the lighting source but other low voltage lighting sources can be used. Heat generated by these sources can be dissipated by conduction to the connected grid system. Additional spring clips can be used if needed.

It can be appreciated that the electrical power supply cables associated with the lamp housing can cooperate with or pass through ports in the modified cross member to gain access to the space above the grid network for electrical connection with a power source.

With this arrangement the low voltage light sources contained within the lamp housing 60 collectively define a finished product and these finished lamp housings can be secured to the grid system after the grid system has been installed. For example, the grid system can be installed with the modified cross members at the desired locations for the strip lighting. As would be common, electricians can then secure as required light fixtures as well as the strip lighting to the exposed grid members. The ceiling panels would then be installed.

T-bar ceiling systems utilize main T members in combination with cross T members that releasably engage the main T-bar members. There are a host of different approaches for connecting of the cross T members to the main T members.

With the lamp housing and the releasable connection of the lamp housing to a cross member, the lamp housing itself can include small projecting flanges for supporting an adjacent edge of a panel. These projecting flanges would be above the lower surface of the housing and be appropriately spaced due to the engagement of the lamp housing of the modified cross member. In this way the lamp housing can be positioned slightly below the finished surface of the cross T ceiling panel system.

It is also possible that the modified cross member could include its own projecting flanges which come down to engage or be positioned adjacent the lower flanges of the main T member. This modified grid member would include a large securing cavity much in the manner of the present system that allows the strip light to be secured to this slightly wider T member.

Various arrangements can be designed to utilize the releasable aspect of the present lamp housing that is sized to cooperate with the ceiling grid system and essentially extends between nodes of the grid system. The advantages of the lamp being capable of being installed to a finished grid system is preferred and allows the grid system to be first installed and then subsequently the electrical fixtures can be installed.

Although various preferred embodiments of the present invention have been described herein in detail, it will be appreciated by those skilled in the art, that variations may be made thereto without departing from the appended claims.

The embodiments of the invention in which an exclusive property or privilege is claimed are defined as follows:

1. A ceiling grid system for receiving LED strip lights, said ceiling grid system comprising a series of connected grid members for supporting and securing the peripheral edge of ceiling panels aligned with said ceiling grid system, wherein at least some of said grid members are light supporting grid members with each light supporting grid member have a downwardly opening recess that extends in the length of the grid member and said downwardly opening recess releasably engages and secures an LED strip light exposed on a lower surface of said grid network.

2. A ceiling grid system as claimed in claim 1 wherein said light supporting grid members include in cross section a top portion comprising two aligned upper flanges extending to opposite sides of a center upwardly opening securing recess, a pair of downwardly extending securing arms either side of said securing recess, a pair of aligned lower flanges extending outwardly either side of a base of said securing recess with said lower flanges being parallel with said upper flanges, and two equal length downwardly extending positioning arms centered either side of and exterior to said securing arms, said positioning arms being of a length to extend substantially below said securing arms; and wherein said LED strip light includes an upwardly opening ‘U’ shaped cavity sized to cooperate with said pair of downwardly extending securing arms and form a releasable connection therewith accurately positioning said LED strip light below said light supporting grid member.

3. A ceiling grid system as claimed in claim 2 wherein said LED strip light includes an elongate housing comprising in cross section a downwardly opening U shaped lamp chamber with a lens cover closing said U shaped chamber, two securing arms extending upwardly and centered on a base of said U shaped lamp chamber and a receiving gap between said upwardly extending securing arms with locking stub arms extending from said securing arms into said receiving gap.

4. A ceiling grid system as claimed in claim 3 wherein said securing arms include a series of fin type cooling extensions on the sides of said securing arms facing outwardly away from said receiving gap.

5. A ceiling grid system as claimed in claim 4 wherein said each of said securing arms include an angled camming surface leading to said securing recess at a free end of each of said securing arms.

6. A ceiling grid system as claimed in claim 5 wherein said elongate housing includes a plurality of spring clips spaced in a length of said elongate housing with said spring clips retained in said receiving gap, and wherein each spring clip is U shaped with a base portion including locking tabs engaging said securing recess and fixing said spring in said recess, each spring clip including spring arms extending away from said base and forming a securing gap between each spring arm and the adjacent securing arm of said elongate housing.

7. A ceiling grid system for receiving LED strip lights, said ceiling grid system comprising a series of connected grid members for supporting and securing the peripheral edge of ceiling panels aligned with said ceiling grid system, wherein at least some of said grid members have a pair of retaining arms defining a downwardly opening recess that extends in the length of the grid member and said retaining arms releasably engage and secure a low voltage strip light with a lower surface of said strip light below said grid network.

8. A ceiling grid system s claimed in claim 7 wherein said low voltage strip light has a series of light emitting diodes spaced in the length of said strip light.

9. A ceiling grid system as claimed in claim 7 wherein said strip light includes an extruded housing having two upwardly extending arms cooperating with a top member of a downwardly opening lamp chamber such that said two upwardly extending arms and said top member form a ‘U’ shaped securing channel.

10. A ceiling grid system as claimed in claim 9 wherein said lamp chamber is of a ‘U’ shaped cross section that is closed by a light transmitting lens member extends across the opening of said ‘U’ shaped cross section.

11. A ceiling grid system as claimed in claim 10 wherein said strip light includes at least two spring clips retained in said ‘U’ shaped securing channel; said spring clips releasably engaging said retaining arms of a respective grid member to secure said strip light below said grid member.

12. A ceiling grid system as claimed in claim 11 wherein each spring clip is of a ‘U’ shaped cross section with two opposed spring arms with each spring arm including a retaining tab lockingly engaging a respective upwardly extending arm of said extruded arms and securing said spring clip between said arms and above said top member.

13. A ceiling grid system as claimed in claim 12 wherein said spring arms engage an inside surface of said pair of retaining arms with said upwardly extending arms of said lamp housing being to the exterior of said retaining arms when the strip light is secured to said grid network.

14. A strip light adapted for securement to a ceiling grid system, said strip light comprising an elongate lamp housing with a downwardly opening lamp chamber and a series of lamps spaced in a length of said lamp chamber; a light transmitting member extending across and at least partially closing said downwardly opening lamp chamber; and wherein said elongate lamp housing includes on an upper surface thereof two upwardly extending members defining a securing structure adapted for securement and engagement aligned below a grid member of a ceiling grid system.

15. A strip light as claimed in claim 14 wherein said two upwardly extending members extend generally the length of said strip light and are of a common cross section.

16. A strip light as claimed in claim 14 including spring clips retained between said two upwardly extending arms and adapted to releasably engage a lower surface of a grid member to secure the lower strip light aligned beneath the grid member.

17. A strip light as claimed in claim 16 wherein said two upwardly extending arms include cooling fines that extend outwardly away from said upwardly extending arms.

18. A strip light as claimed in claim 17 wherein said elongate lamp housing is made of an extruded aluminum member.
